(19) United States
(12) Patent Application Publication
(10) Pub. No.: US 2026/0370541 A1
(43) Pub. Date: Nov. 19, 2026

(54) SYSTEMS AND METHODS FOR AUTOMATED VEHICULAR-NETWORK TROUBLESHOOTING

(71) Applicant: Toyota Motor North America, Inc., Plano, TX (US)

(72) Inventors: Ankit Mehta, Frisco, TX (US); Jae W. Hur, Carrollton, TX (US)

(73) Assignees: Toyota Motor North America, Inc., Plano, TX (US); Toyota Jidosha Kabushiki Kaisha, Toyota-shi (JP)

(21) Appl. No.: 19/209,279

(22) Filed: May 15, 2025

(51) Int. Cl. H04L 41/0631; H04L 67/12

(52) U.S. Cl. CPC H04L 41/0636; H04L 67/12

(57) ABSTRACT

Systems and methods described herein relate to automated vehicular-network troubleshooting. One embodiment is a Network Monitoring System (NMS) Analyzer that automatically collects telematics communication device (TCD) data from one or more connected vehicles in response to a detected communication fault between the one or more connected vehicles and a network. The NMS Analyzer also automatically identifies, using a predetermined decision tree, a root cause of the detected communication fault and determines whether the root cause stems from the one or more connected vehicles or the network. The NMS Analyzer also automatically assigns resolution of the detected communication fault to a party responsible for correcting the root cause of the detected communication fault.

### TECHNICAL FIELD

The subject matter described herein relates in general to vehicular communication networks and, more specifically, to systems and methods for automated vehicular-network troubleshooting.

### BACKGROUND

The increasing number of connected vehicles—vehicles that are capable of communicating with the Internet, other vehicles, and external devices—on roadways has made the troubleshooting of communication faults in vehicular networks an important topic. Currently, when a communication fault occurs, a troubleshooting team, using data collected from vehicle users, attempts to re-create the communication fault to determine the “when, where, and how” of the communication fault. This process is cumbersome, time-consuming, and expensive.

### SUMMARY

Embodiments of systems and methods for automated vehicular-network troubleshooting are presented herein. One embodiment is a Network Monitoring System (NMS) Analyzer, comprising a processor and a memory storing machine-readable instructions that, when executed by the processor, cause the processor to collect automatically telematics communication device (TCD) data from one or more connected vehicles in response to a detected communication fault between the one or more connected vehicles and a network. The memory also stores machine-readable instructions that, when executed by the processor, cause the processor to identify automatically, using a predetermined decision tree, a root cause of the detected communication fault and determine whether the root cause stems from the one or more connected vehicles or the network. The memory also stores machine-readable instructions that, when executed by the processor, cause the processor to assign automatically resolution of the detected communication fault to a party responsible for correcting the root cause of the detected communication fault.

Another embodiment is a non-transitory computer-readable medium for automated vehicular-network troubleshooting and storing instructions that, when executed by a processor, cause the processor to collect automatically, at a NMS Analyzer, TCD data from one or more connected vehicles in response to a detected communication fault between the one or more connected vehicles and a network. The instructions also cause the processor to identify automatically, at the NMS Analyzer using a predetermined decision tree, a root cause of the detected communication fault and determine whether the root cause stems from the one or more connected vehicles or the network. The instructions also cause the processor to assign automatically, from the NMS Analyzer, resolution of the detected communication fault to a party responsible for correcting the root cause of the detected communication fault.

Another embodiment is a method of automated vehicular-network troubleshooting, the method comprising collecting automatically, at a NMS Analyzer, TCD data from one or more connected vehicles in response to a detected communication fault between the one or more connected vehicles and a network. The method also includes identifying automatically, at the NMS Analyzer using a predetermined decision tree, a root cause of the detected communication fault and determining whether the root cause stems from the one or more connected vehicles or the network. The method also includes assigning automatically, from the NMS Analyzer, resolution of the detected communication fault to a party responsible for correcting the root cause of the detected communication fault.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 is a block diagram of a vehicle manufacturer cloud platform in which various embodiments of a Network Monitoring System (NMS) Analyzer can be implemented.

FIGS. 2A-2D are diagrams of a predetermined decision tree used by a NMS Analyzer, in accordance with an illustrative embodiment of the invention.

FIG. 3 is a block diagram of a NMS Analyzer, in accordance with an illustrative embodiment of the invention.

FIG. 4 is a flowchart of a method of automated vehicular-network troubleshooting, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments of systems and methods for automated vehicular-network troubleshooting are described herein. More specifically, various embodiments of a Network Monitoring System (NMS) Analyzer and associated methods are disclosed. The various embodiments of a NMS Analyzer obviate the cumbersome, time-consuming, and expensive manual troubleshooting process mentioned in the Background through intelligent automation. For example, in one embodiment, the NMS Analyzer automatically collects telematics communication device (TCD) data from one or more connected vehicles in response to a detected communication fault between the one or more connected vehicles and a network. The NMS Analyzer, using a predetermined decision tree, automatically identifies a root cause of the detected communication fault and determines whether the root cause stems from the one or more connected vehicles or the network. That is, the NMS Analyzer determines whether the detected communication fault is located on the vehicle side or the network side. As those skilled in the art are aware, that determination is one of the most challenging aspects of vehicular-network troubleshooting.

The NMS Analyzer then automatically assigns resolution of the detected communication fault to a party responsible for correcting the root cause of the detected communication fault. For example, if the root cause stems from the network operated by the Mobile Network Operator (MNO), the MNO is responsible for correcting the detected communication fault, and the NMS Analyzer assigns resolution to the MNO. On the other hand, if the root cause stems from the TCD of a connected vehicle, for example, the supplier of the TCD is responsible for correcting the detected communication fault, and the NMS Analyzer assigns resolution to the equipment supplier. Automatically identifying the root cause of the communication fault and assigning resolution of the communication fault to the correct party promptly greatly shortens the time required to resolve the issue.

As mentioned above, one aspect of the various embodiments of a NMS Analyzer described herein is the use of a predetermined decision tree in identifying the root cause of a detected communication fault and determining the location of the root cause (vehicle side or network side). For example, in one embodiment, the predetermined decision tree directs the NMS Analyzer, after determining that a particular connected vehicle among the one or more connected vehicles is not connected to the network by analyzing Device Connectivity Enablement (DCE) Log information in the collected TCD data, to determine whether the detected communication fault is a recurring communication fault by analyzing the DCE Log information from other vehicles among the one or more connected vehicles.

Also, in the embodiment just mentioned, the predetermined decision tree directs the NMS Analyzer, after determining that a particular connected vehicle among the one or more connected vehicles is connected to the network by analyzing DCE Log information in the TCD data, to (1) check signal strength, signal quality, and signal-to-noise ratio and (2) determine whether the particular connected vehicle experienced an attachment failure. In this embodiment, the predetermined decision tree directs the NMS Analyzer to check Public Data Network (PDN) connectivity of the particular connected vehicle, if the NMS Analyzer determines that the particular connected vehicle did not experience an attachment failure. Also, in this embodiment, the predetermined decision tree directs the NMS Analyzer to check the IP Multimedia Subsystem (IMS) registration status of the particular connected vehicle, if the NMS analyzer determines that the particular connected vehicle has PDN connectivity.

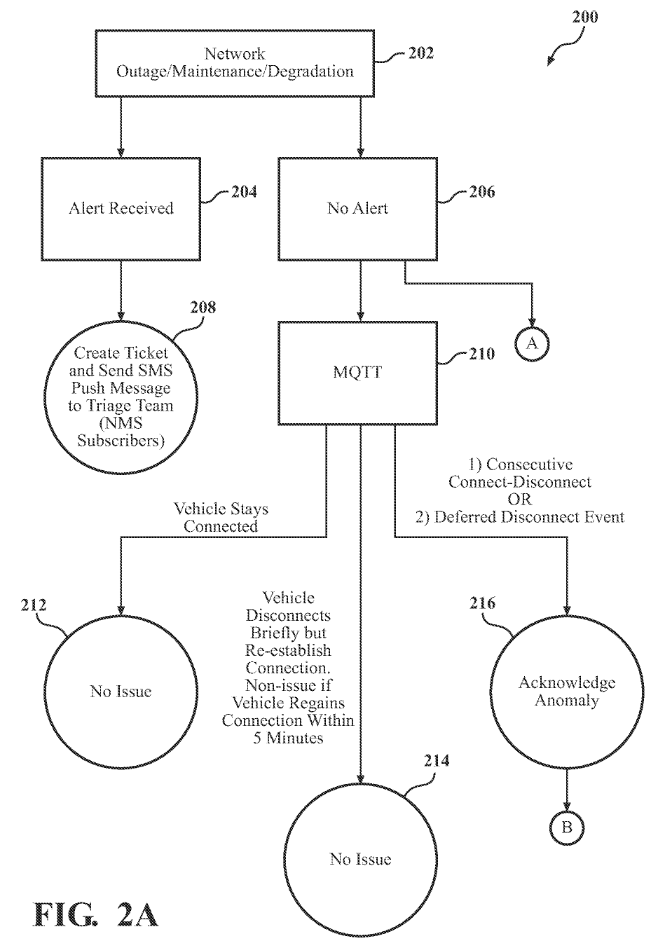

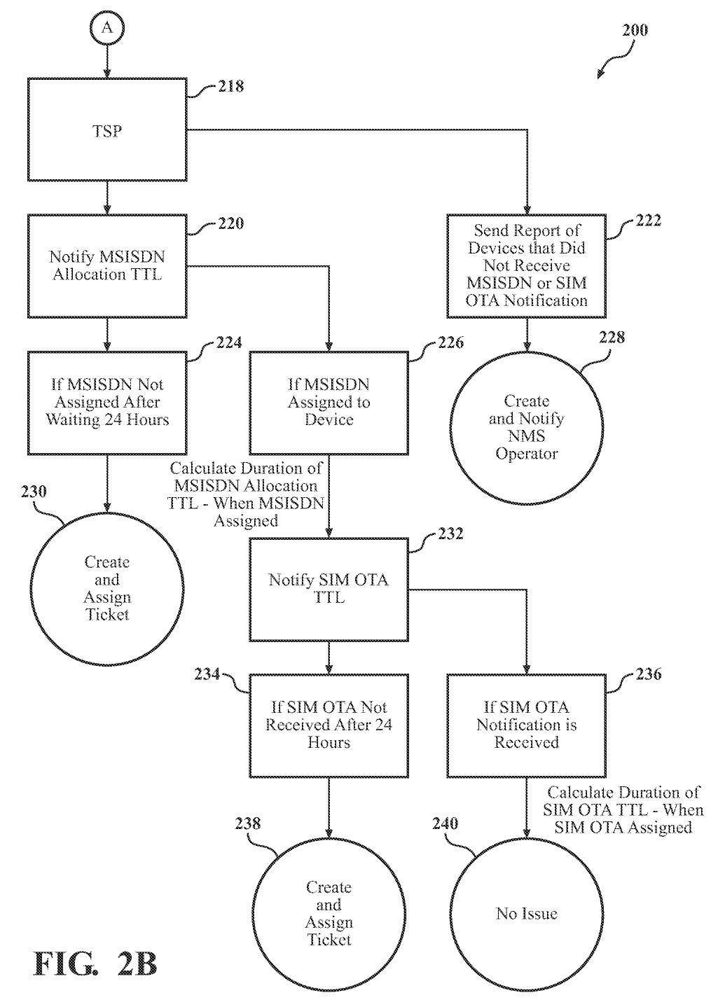

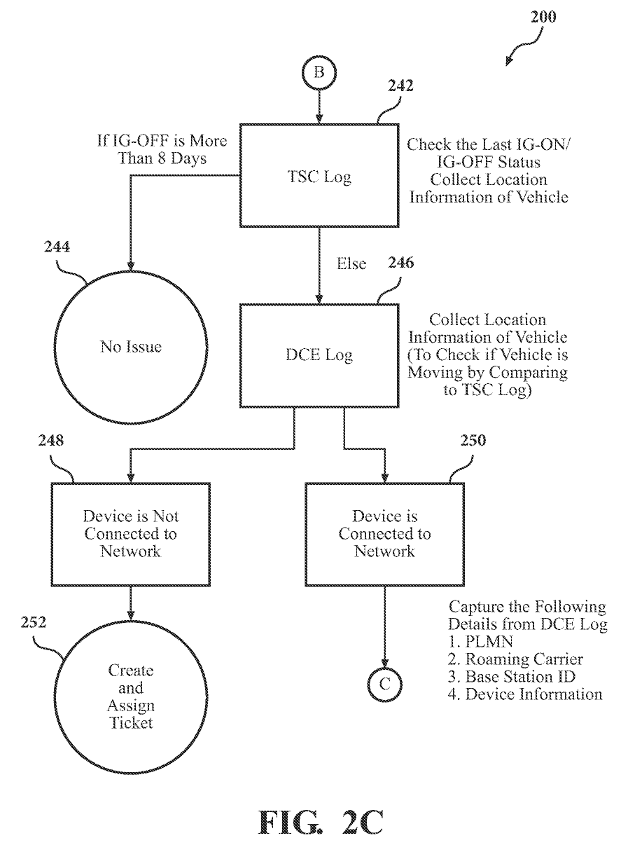

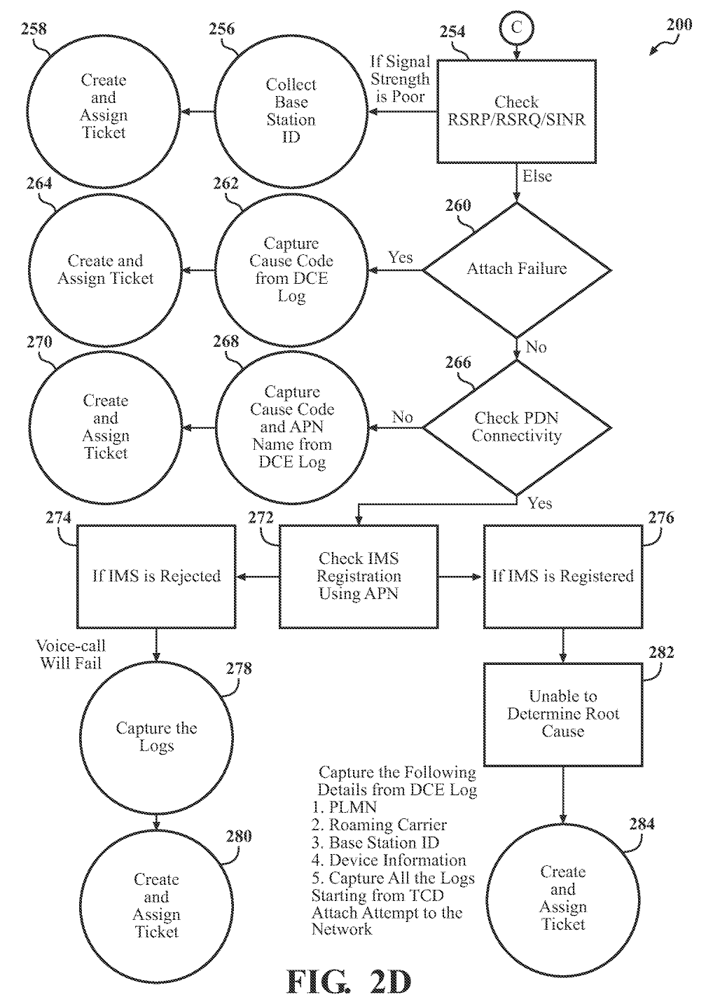

The foregoing are just some examples of troubleshooting strategies that can be applied via the decision tree. One illustrative decision tree is discussed in greater detail below in connection with FIGS. 2A-2D.

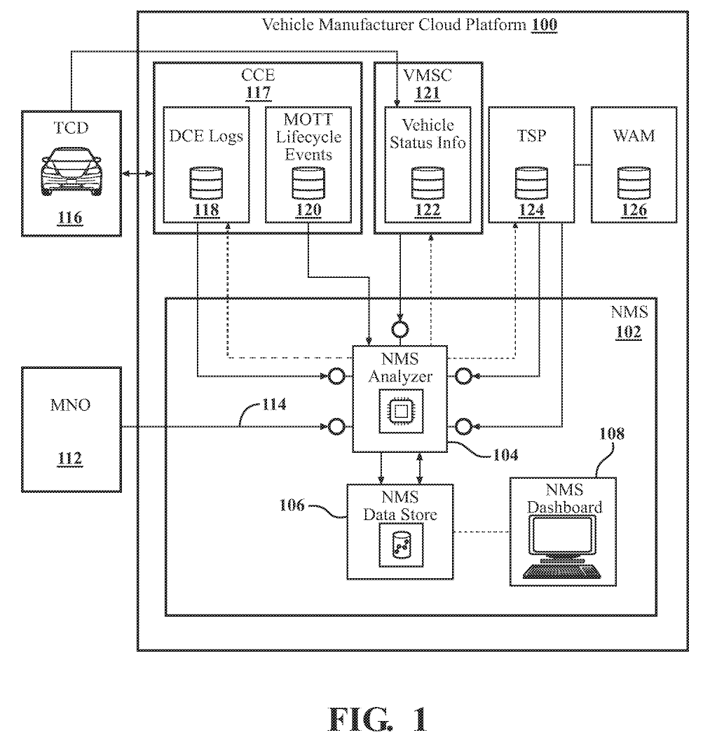

FIG. 1 is a block diagram of a vehicle manufacturer cloud platform 100 (hereinafter often referred to as the “cloud platform 100”) in which various embodiments of a NMS Analyzer 104 can be implemented. The context for the cloud platform 100 shown in FIG. 1 is that a vehicle manufacturer manufactures connected vehicles (not shown in FIG. 1) for which the vehicle manufacturer provides ongoing service and support. Each connected vehicle includes a telematics communication device (TCD) 116—a device that essentially serves as a connected vehicle’s Internet access point. The TCD 116 thus acts like a modem to connect the vehicle to one or more communication networks, which can include the Internet. As those skilled in the art are aware, various Original Equipment Manufacturers (OEMs) refer to a device with the functionality of TCD 116 by different names. Some OEMs call such a device a Telematics Control Unit (TCU). Others call it an electronic control unit (ECU), and still others refer to it as a Data Communication Module (DCM). Herein, the term “telematics communication device (TCD)” encompasses all of those and any other equivalent device having the same or similar functionality. The TCD 116 is responsible for transmitting collected data regarding the connected vehicle’s operational status (e.g., fuel level, tire pressure, etc.) and location-tracking data to support services that rely on location information. A connected vehicle’s TCD 116 transmits these various kinds of vehicle information to the cloud platform 100.

In communicating with other network nodes (servers, other vehicles, infrastructure systems, etc.), the TCD 116 of a given connected vehicle can employ technologies such as cellular data (LTE, 5G, 6G, etc.), IEEE 802.11 (WiFi), Bluetooth^{®}, Bluetooth^{®} Low Energy (Bluetooth^{®} LE), and Dedicated Short-Range Communications (DSRC).

As shown in FIG. 1, cloud platform 100 includes a Network Monitoring System (NMS) 102 operated by the vehicle manufacturer that monitors the status and performance of a communication network provided by a MNO 112 to connected vehicles manufactured by the vehicle manufacturer. In some embodiments, the NMS 102 includes a NMS dashboard 108, which serves as a user interface for a network operations team of the vehicle manufacturer. Herein, the primary component of the NMS 102 of interest is the NMS Analyzer 104 and its associated NMS data store 106.

As shown in FIG. 1, NMS Analyzer 104 receives various kinds of information from multiple sources. The solid lines running from those sources to the NMS Analyzer 104 represent the various kinds of input data that the NMS Analyzer 104 analyzes. The dotted lines running from the NMS Analyzer 104 to the information sources represent registration messages that enable the NMS Analyzer 104 to receive the inputs. At a high level, the information sources include the TCDs 116 of connected vehicles, the MNO 112, a Cloud Connectivity Enablement (CCE) server 117, a Vehicle Manufacturer Service Center (VMSC) server 121, a Telematics Service Platform (TSP) 124, and a Wireless Account Manager (WAM) 126. In some embodiments, the CCE server 117, VMSC server 121, TSP 124, and WAM 126 are separate components operated by the vehicle manufacturer as part of the overall vehicle manufacturer cloud platform 100.

The NMS Analyzer 104 can receive, via incident notification 114, notification of issues such as planned MNO maintenance, an outage in a specific region or regions of which the MNO is aware and that the MNO desires to report, etc. The NMS 104 can forward (e.g., broadcast) such information to whomever is subscribed to receive it (e.g., an operations team of the vehicle manufacturer associated with the NMS 102).

In the embodiment of FIG. 1, CCE server 117 has two components, DCE Log information 118 and Message Queuing Telemetry Transport (MQTT) lifecycle events 120. The NMS Analyzer 104 monitors information from those two sources, among other information sources, in connection with detecting network and/or connection issues (communication faults). More specifically, the NMS Analyzer 104 monitors MQTT lifecycle events 120 to detect when a vehicle’s TCD 116 disconnects from the network to determine whether the disconnection was normal (e.g., the vehicle’s operator turned off the vehicle’s ignition), abnormal but insignificant (e.g., a brief disconnection due to the vehicle traveling through a tunnel where there is no network reception), or abnormal and requiring the investigation of a communication fault (e.g., an unexpected and prolonged disconnection).

VMSC server 121 keeps track of vehicle status information 122, particularly location and operational status (ignition on or off), which it obtains from the vehicles’ respective TCDs 116. In this embodiment, VMSC server 121 is aware that the vehicles’ TCDs 116 include internal logic to shut down after a predetermined idle period to conserve battery charge. After the TCD 116 has been shut down for the predetermined period (e.g., several days), the TCD 116 goes into a “deep sleep” (power-saving) mode. This information is used in conjunction with the MQTT lifecycle events 120 to determine whether a vehicle disconnection from the MNO’s network is normal (e.g., the customer simply has not used the vehicle for a while) or abnormal (a network and/or connection issue—a communication fault).

Regarding the TSP 124, the WAM 126 provides information from the MNO 112 regarding the status of customer Subscriber Identity Module (SIM) data in the TCD 116 (i.e., whether the customer’s SIM has been activated with the MNO 112). This information also pertains to determining whether there are any SIM-related provisioning failures at the MNO 112. The MNO, though it has that information, does not send it directly to the vehicle manufacturer, in this embodiment, but WAM 126 detects whether customers (connected-vehicle users) have experienced any SIM-related provisioning failures. If so, WAM 126 reports that to TSP 124, which shares that information with the NMS Analyzer 104. Some of the services in the TCD 116 rely on the SIM being activated on the network (with the MNO 112). Sometimes, however, the provisioning of the customer's SIM activation fails.

The NMS 102 stores, in NMS data store 106, data pertaining to a particular detected communication fault. Via the NMS data store 106, the query interface 110, and the NMS dashboard 108, the NMS 102 can notify the vehicle manufacturer’s network operations team of network status and detected communication faults. In some embodiments, a predetermined decision tree (not shown in FIG. 1) that the NMS Analyzer 104 uses to identify automatically a root cause of a detected communication fault and to determine whether the root case stems from one or more connected vehicles or the MNO’s network is stored in the NMS data store 106. In other embodiments, the decision tree is stored elsewhere (e.g., in a data store that is part of the NMS Analyzer 104 itself).

As discussed above, once the NMS Analyzer 104 has detected or otherwise been informed of a communication fault between one or more connected vehicles and the MNO’s network, the NMS Analyzer 104 responds by automatically collecting TCD data from the respective TCDs 116 of the one or more connected vehicles. The NMS Analyzer 104 then uses a predetermined decision tree to identify the root cause of the detected communication fault and to determine whether the root cause stems from the one or more connected vehicles or the network (i.e., from the vehicle side or the network side). An illustrative predetermined decision tree is discussed in greater detail below in connection with FIGS. 2A-2D.

FIGS. 2A-2D are diagrams of a predetermined decision tree 200 used by a NMS Analyzer 104, in accordance with an illustrative embodiment of the invention. Each of FIGS. 2A-2D is a portion of the decision tree 200, so that same reference numeral is repeated at the top of each of the figures.

Referring to FIG. 2A and beginning at block 202, the NMS Analyzer 104 checks whether an alert has been received from the MNO 112 regarding scheduled maintenance, an outage, or an observed service degradation. If so (block 204), the NMS Analyzer 104 creates a ticket for tracking purposes and notifies NMS subscribers (e.g., a vehicle manufacturer’s network operations team) via, e.g., SMS push notifications, due to the criticality of the situation (block 208). In the absence of an alert (block 206), the NMS Analyzer 104 considers the MQTT data mentioned above (block 210). If the vehicle remains connected to the network or disconnects only briefly and reestablishes connection within, e.g., five minutes, there is no issue (blocks 212 and 214, respectively). However (block 216), if connect-disconnect events occur persistently (the NMS Analyzer 104 checks every five minutes, in this embodiment) or the disconnect “reason code” is abnormal, the NMS Analyzer 104 flags the situation as anomalous and investigates further (see Connection Point B, “TSC Log,” in FIG. 2C below). Another branch from block 206 in FIG. 2A leads to Connection Point A in FIG. 2B, which is discussed next.

Referring to FIG. 2B and continuing from Connection Point A in FIG. 2A at block 218, information from WAM 126, which has no direct communication with the NMS Analyzer 104, as discussed above, is made available to the NMS Analyzer 104 via the TSP 124. TSP 124 notifies the NMS Analyzer 104 of the Mobile Station International Subscriber Directory Number (MSISDN) Allocation Time to Live (TTL), part of the SIM provisioning process, at block 220. If the MSISDN is not assigned within 24hours (block 224), NMS Analyzer 104 creates a ticket for the MNO 112 to investigate (block 230). If the MSISDN is assigned to a device (block 226), the NMS Analyzer 104 checks the SIM over-the-air (OTA) notifying the device that the provisioning is completed (block 232). If that is not received within 24 hours (block 234), the NMS Analyzer 104 creates a ticket for the MNO to investigate (block 238). If the SIM OTA is received (block 236), there is no issue (block 240). If a device did not receive a MSISDN or SIM OTA notification (block 222), the NMS Analyzer 104 creates a ticket for the vehicle manufacturer’s network operations team to follow up (block 228). The network operations team can send a comprehensive periodic report (e.g., generated daily) of such anomalies to the MNO 112 so the MNO 112 can investigate and correct the issues.

Referring to FIG. 2C, continuing from Connection Point B in FIG. 2A, since a communication fault has been detected, the NMS Analyzer 104 collects the vehicle's VIN (Vehicle Identification Number) from MQTT. The NMS Analyzer 104 checks the vehicle's last known ignition-on (IG-ON) and ignition-off (IG-OFF) status and collects the vehicle's location information (block 242). If the vehicle’s ignition has been off for more than eight days (block 244), the NMS Analyzer 104 determines that there is no issue (because the TCD 116 has gone into a deep-sleep power-saving mode). Otherwise (if the IG-OFF condition has not exceeded eight days), the NMS checks the DCE Log information 118 to determine where the vehicle was traveling when the communication fault arose (block 246). If the device (vehicle) was not connected to the network (block 248), the NMS Analyzer 104 creates a ticket for an MNO 112 investigation (block 252). If the vehicle was connected to the network (block 250), the NMS Analyzer 104 captures, from the DCE Log information 118, the Public Land Mobile Network (PLMN), the roaming carrier (if applicable), the base station ID, and the device’s (vehicle’s) information. FIG. 2C leads to Connection Point C in FIG. 2D.

Referring to FIG. 2D, The NMS Analyzer 104 checks the Reference Signal Power/Reference Signal Quality/Signal-to-Noise Ratio (RSRP/RSRQ/SINR) at block 254. If the signal strength is poor, the NMS Analyzer 104 collects the base station ID (block 256) and creates and assigns a ticket (block 258) for an MNO 112 investigation (i.e., the ticket is assigned to the MNO partner 112). Otherwise, if the signal strength is okay, the NMS Analyzer 104 checks to see whether there was an attachment failure (block 260). If so, the NMS Analyzer 104 captures the “cause code” from the DCE Log information 118 (block 262) and creates a ticket for an MNO 112 investigation (block 264). If attachment was successful, the NMS Analyzer 104 checks for Public Data Network (PDN) connectivity (block 266). If there was no PDN connectivity, the NMS Analyzer 104 captures the “cause code” and Access Point Name (APN) from the DCE Log information 118 (block 268) and creates a ticket for an MNO 112 investigation (block 270). If there was PDN connectivity, the NMS Analyzer 104 checks the IP Multimedia Subsystem (IMS) registration based on the APN (block 272). If the IMS is rejected (block 274), that means a voice call will fail. In that case, the NMS Analyzer 104 captures the relevant log data (block 278) and creates a ticket for a MNO 112 investigation (block 280). If IMS registration was successful (block 276), the NMS Analyzer 104 is unable to determine the root cause (it has exhausted the available information at block 282), so it gathers all the relevant information such as PLMN, roaming carrier (if applicable), base station ID, device information, and all pertinent log data from the TCD 116 to create a ticket for a MNO 112 investigation (block 284).

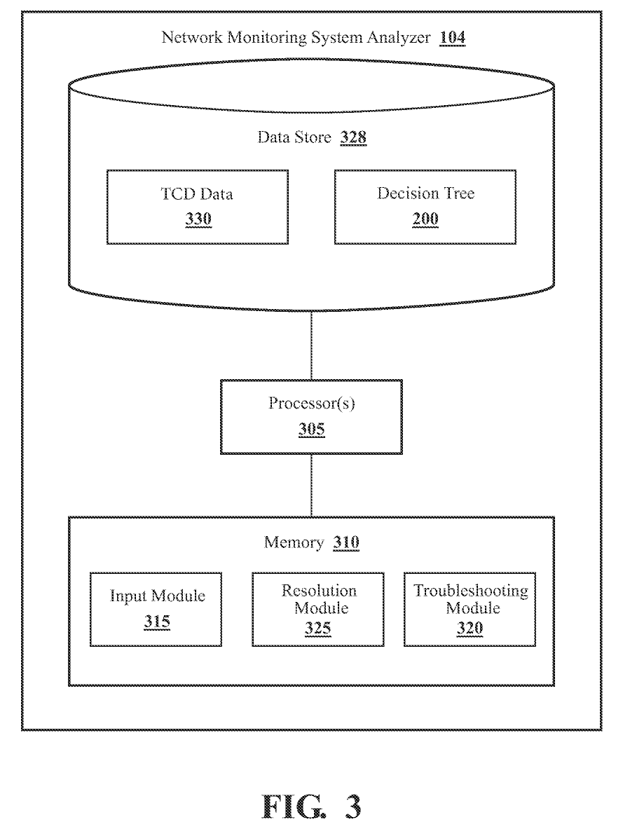

FIG. 3 is a block diagram of a NMS Analyzer 104, in accordance with an illustrative embodiment of the invention. In FIG. 3, NMS Analyzer 104 includes one or more processors 305 to which a memory 310 is communicably coupled, the memory 310 storing machine-readable instructions that are executed by the one or more processors 305. The one or more processors 305 can be one or more dedicated processors, or the one or more processors 305 can coincide with one or more processors of the vehicle manufacturer cloud platform 100 discussed above in connection with FIG. 1. Memory 310 stores an input module 315, a troubleshooting module 320, and a resolution module 325. The memory 310 is a random-access memory (RAM), read-only memory (ROM), a hard-disk drive, a flash memory, or other suitable non-transitory memory for storing the modules 315, 320, and 325. The modules 315, 320, and 325 are, for example, machine-readable instructions that, when executed by the one or more processors 305, cause the one or more processors 305 to perform the various functions disclosed herein.

As shown in FIG. 3, NMS Analyzer 104 can store various kinds of data in a data store 328. In some embodiments, the data store 328 is separate from the NMS data store 106 discussed above in connection with FIG. 1. In other embodiments, the NMS data store 106 and the data store 328 are one and the same. Data store 328 stores data such as TCD data 330 from connected vehicles and one or more decision trees 200 such as the decision tree 200 discussed above in detail in connection with FIGS. 2A-2D. As discussed above, TCD data 330 can include various types of data, including, without limitation, DCE Log information 118 and vehicle status information 122.

Input module 315 generally includes machine-readable instructions that, when executed by the one or more processors 305, cause the one or more processors 305 to collect automatically TCD data 330 from one or more connected vehicles in response to a detected communication fault between the one or more connected vehicles and a network. As discussed above, each connected vehicle includes a TCD 116, a device that essentially serves as a connected vehicle’s Internet access point. The TCD 116 thus acts like a modem to connect the vehicle to one or more communication networks, which can include the Internet. The TCD 116 also transmits collected data regarding the connected vehicle’s operational status (e.g., fuel level, tire pressure, etc.) and location-tracking data to support services that rely on location information. A connected vehicle’s TCD 116 transmits these various kinds of vehicle information to the cloud platform 100 that hosts the NMS Analyzer 104.

Troubleshooting module 320 generally includes machine-readable instructions that, when executed by the one or more processors 305, cause the one or more processors 305 to identify automatically, using a predetermined decision tree 200, a root cause of the detected communication fault and determine whether the root cause stems from the one or more connected vehicles or the network. An illustrative predetermined decision tree 200 is discussed in detail above in connection with FIGS. 2A-2D. A key feature of the NMS Analyzer 104 is that it determines whether the communication fault lies with the vehicle side or the network side so the correct party can be assigned resolution of the communication fault through correction of the root cause, as discussed above.

Resolution module 325 generally includes machine-readable instructions that, when executed by the one or more processors 305, cause the one or more processors 305 to assign automatically resolution of the detected communication fault to a party responsible for correcting the root cause of the detected communication fault. As discussed above, in some situations the MNO 112 is responsible for correcting the root cause of the detected communication fault (a problem with the network), so resolution module 325 assigns resolution to the MNO 112. In other situations, the supplier of the TCDs 116 is responsible for correcting the root cause of the detected communication fault (a problem with the TCD 116 of a vehicle), so the NMS Analyzer 104 assigns resolution to the TCD supplier.

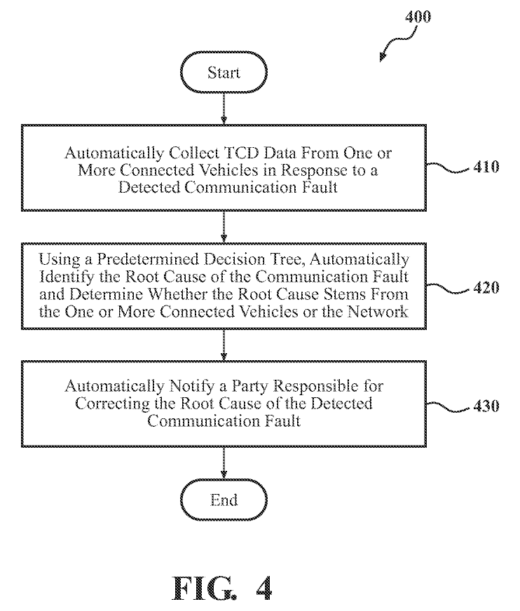

FIG. 4 is a flowchart of a method 400 of automated vehicular-network troubleshooting, in accordance with an illustrative embodiment of the invention. Method 400 will be discussed from the perspective of NMS Analyzer 104 in FIG. 3. While method 400 is discussed in combination with NMS Analyzer 104, it should be appreciated that method 400 is not limited to being implemented within NMS Analyzer 104, but NMS Analyzer 104 is instead one example of a system that may implement method 400.

At block 410, input module 315 collects automatically TCD data 330 from one or more connected vehicles in response to a detected communication fault between the one or more connected vehicles and a network. As discussed above, each connected vehicle includes a TCD 116, a device that essentially serves as a connected vehicle’s Internet access point. The TCD 116 thus acts like a modem to connect the vehicle to one or more communication networks, which can include the Internet. The TCD 116 also transmits collected data regarding the connected vehicle’s operational status (e.g., fuel level, tire pressure, etc.) and location-tracking data to support services that rely on location information. A connected vehicle’s TCD 116 transmits these various kinds of vehicle information to the cloud platform 100 that hosts the NMS Analyzer 104.

At block 420, troubleshooting module 320 identifies automatically, using a predetermined decision tree 200, a root cause of the detected communication fault and determines whether the root cause stems from the one or more connected vehicles or the network. An illustrative predetermined decision tree 200 is discussed in detail above in connection with FIGS. 2A-2D. A key feature of the NMS Analyzer 104 is that it determines whether the communication fault lies with the vehicle side or the network side so the correct party can be assigned resolution of the communication fault through correction of the root cause, as discussed above.

At block 430, resolution module 325 assigns automatically resolution of the detected communication fault to a party responsible for correcting the root cause of the detected communication fault. As discussed above, in some situations the MNO 112 is responsible for correcting the root cause of the detected communication fault (a problem with the network), so resolution module 325 assigns resolution to the MNO 112. In other situations, the supplier of the TCDs 116 is responsible for correcting the root cause of the detected communication fault (a problem with the TCD 116 of a vehicle), so the NMS Analyzer 104 assigns resolution to the TCD supplier.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The components described above can be realized in hardware or a combination of hardware and software and can be realized in a centralized fashion in one processing system or in a distributed fashion where different elements are spread across several interconnected processing systems. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer, or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of … and ….” As used herein refers to and encompasses any and all possible combinations of one or more of the associated listed items. As an example, the phrase “at least one of A, B, and C” includes A only, B only, C only, or any combination thereof (e.g. AB, AC, BC or ABC).

As used herein, “cause” or “causing” means to make, command, instruct, and/or enable an event or action to occur or at least be in a state where such event or action may occur, either in a direct or indirect manner.

Aspects herein can be embodied in other forms without departing from the spirit or essential attributes thereof. Accordingly, reference should be made to the following claims rather than to the foregoing specification, as indicating the scope hereof.

What is claimed is:

1. A Network Monitoring System (NMS) Analyzer, comprising:
a processor; and
a memory storing machine-readable instructions that, when executed by the processor, cause the processor to:
collect automatically telematics communication device (TCD) data from one or more connected vehicles in response to a detected communication fault between the one or more connected vehicles and a network;
identify automatically, using a predetermined decision tree, a root cause of the detected communication fault and determine whether the root cause stems from the one or more connected vehicles or the network; and
assign automatically resolution of the detected communication fault to a party responsible for correcting the root cause of the detected communication fault.

2. The NMS Analyzer of claim 1, wherein the party responsible for correcting the root cause of the detected communication fault is a Mobile Network Operator that operates the network.

3. The NMS Analyzer of claim 1, wherein the party responsible for correcting the root cause of the detected communication fault is a supplier of TCDs for the one or more connected vehicles.

4. The NMS Analyzer of claim 1, wherein the predetermined decision tree directs the NMS Analyzer, after determining that a particular connected vehicle among the one or more connected vehicles is not connected to the network by analyzing Device Connectivity Enablement (DCE) Log information in the TCD data, to determine whether the detected communication fault is a recurring communication fault by analyzing the DCE Log information from other vehicles among the one or more connected vehicles.

5. The NMS Analyzer of claim 1, wherein the predetermined decision tree directs the NMS Analyzer, after determining that a particular connected vehicle among the one or more connected vehicles is connected to the network by analyzing Device Connectivity Enablement (DCE) Log information in the TCD data, to:
check signal strength, signal quality, and signal-to-noise ratio; and
determine whether the particular connected vehicle experienced an attachment failure.

6. The NMS Analyzer of claim 5, wherein the predetermined decision tree directs the NMS Analyzer to check Public Data Network (PDN) connectivity of the particular connected vehicle, when the NMS Analyzer determines that the particular connected vehicle did not experience an attachment failure.

7. The NMS Analyzer of claim 6, wherein the predetermined decision tree directs the NMS Analyzer to check IP Multimedia Subsystem (IMS) registration status of the particular connected vehicle, when the NMS analyzer determines that the particular connected vehicle has PDN connectivity.

8. A non-transitory computer-readable medium storing instructions that, when executed by a processor, cause the processor to:
collect automatically, at a Network Monitoring System (NMS) Analyzer, telematics communication device (TCD) data from one or more connected vehicles in response to a detected communication fault between the one or more connected vehicles and a network;
identify automatically, at the NMS Analyzer using a predetermined decision tree, a root cause of the detected communication fault and determine whether the root cause stems from the one or more connected vehicles or the network; and
assign automatically, from the NMS Analyzer, resolution of the detected communication fault to a party responsible for correcting the root cause of the detected communication fault.

9. The non-transitory computer-readable medium of claim 8, wherein the party responsible for correcting the root cause of the detected communication fault is one of a Mobile Network Operator that operates the network and a supplier of TCDs for the one or more connected vehicles.

10. The non-transitory computer-readable medium of claim 8, wherein the predetermined decision tree directs the NMS Analyzer, after determining that a particular connected vehicle among the one or more connected vehicles is not connected to the network by analyzing Device Connectivity Enablement (DCE) Log information in the TCD data, to determine whether the detected communication fault is a recurring communication fault by analyzing the DCE Log information from other vehicles among the one or more connected vehicles.

11. The non-transitory computer-readable medium of claim 8, wherein the predetermined decision tree directs the NMS Analyzer, after determining that a particular connected vehicle among the one or more connected vehicles is connected to the network by analyzing Device Connectivity Enablement (DCE) Log information in the TCD data, to:
check signal strength, signal quality, and signal-to-noise ratio; and
determine whether the particular connected vehicle experienced an attachment failure.

12. The non-transitory computer-readable medium of claim 11, wherein the predetermined decision tree directs the NMS Analyzer to check Public Data Network (PDN) connectivity of the particular connected vehicle, when the NMS Analyzer determines that the particular connected vehicle did not experience an attachment failure.

13. The non-transitory computer-readable medium of claim 12, wherein the predetermined decision tree directs the NMS Analyzer to check IP Multimedia Subsystem (IMS) registration status of the particular connected vehicle, when the NMS analyzer determines that the particular connected vehicle has PDN connectivity.

14. A method, comprising:
collecting automatically, at a Network Monitoring System (NMS) Analyzer, telematics communication device (TCD) data from one or more connected vehicles in response to a detected communication fault between the one or more connected vehicles and a network;
identifying automatically, at the NMS Analyzer using a predetermined decision tree, a root cause of the detected communication fault and determining whether the root cause stems from the one or more connected vehicles or the network; and
assigning automatically, from the NMS Analyzer, resolution of the detected communication fault to a party responsible for correcting the root cause of the detected communication fault.

15. The method of claim 14, wherein the party responsible for correcting the root cause of the detected communication fault is a Mobile Network Operator that operates the network.

16. The method of claim 14, wherein the party responsible for correcting the root cause of the detected communication fault is a supplier of TCDs for the one or more connected vehicles.

17. The method of claim 14, wherein the predetermined decision tree directs the NMS Analyzer, after determining that a particular connected vehicle among the one or more connected vehicles is not connected to the network by analyzing Device Connectivity Enablement (DCE) Log information in the TCD data, to determine whether the detected communication fault is a recurring communication fault by analyzing the DCE Log information from other vehicles among the one or more connected vehicles.

18. The method of claim 14, wherein the predetermined decision tree directs the NMS Analyzer, after determining that a particular connected vehicle among the one or more connected vehicles is connected to the network by analyzing Device Connectivity Enablement (DCE) Log information in the TCD data, to:
check signal strength, signal quality, and signal-to-noise ratio; and
determine whether the particular connected vehicle experienced an attachment failure.

19. The method of claim 18, wherein the predetermined decision tree directs the NMS Analyzer to check Public Data Network (PDN) connectivity of the particular connected vehicle, when the NMS Analyzer determines that the particular connected vehicle did not experience an attachment failure.

20. The method of claim 19, wherein the predetermined decision tree directs the NMS Analyzer to check IP Multimedia Subsystem (IMS) registration status of the particular connected vehicle, when the NMS analyzer determines that the particular connected vehicle has PDN connectivity.
